(19) United States
(12) Patent Application Publication
(10) Pub. No.: US 2008/0157711 A1
(43) Pub. Date: Jul. 3, 2008

(54) Portable device charging module

(76) Inventors: Kuo Ching Chiang, Linkou Township (TW); Ching Yu Chang, Yi Lan Xian (TW); Chi Wen Liu, Hsin Chu City (TW)

Correspondence Address: BIRCH STEWART KOLASCH & BIRCH, PO BOX 747, FALLS CHURCH, VA, 22040-0747, US

(21) Appl. No.: 11/648,796

(22) Filed: Jan. 3, 2007

(51) Int. Cl. H02J 7/35

(52) U.S. Cl. 320/101

(57) ABSTRACT

A portable device comprising: a main body; a display and a keypad formed on the main body; a MP3 or MP4 codec formed within the main body; a memory coupled to the MP3 or MP4 codec; an audio process coupled to the MP3 or MP4 codec; a D/A converter coupled to the audio process; a solar cell array attached to an outer surface of the main body so as to be exposed to an external environment for generating a voltage when light is received. The memory includes nonvolatile memory or hard disc.

### TECHNICAL FIELD

The present invention relates, in general, to a wireless charger for portable device, more particularly, to a wireless charger with solar cells.

### BACKGROUND ART

The typical battery of cellular is well-known a nickel-cadmium (Ni——Cd) battery, a nickel-hydrogen (Ni——H) battery, a lithium-ion (Li-ion) battery, etc. However, since the battery technology lags behind the communication technology, the lift time of the battery is not long enough for daily life. U.S. Pat. No. 7,071,652 disclosed a charging control entitled “Methods and systems for battery charging control based on CMOS technology”. U.S. Pat. No. 5,371,456 disclosed a charger entitled U.S. Pat. No. 5,371,456 “Power supply and battery charging system”. U.S. Pat. No. No. 6,184,655 disclosed Battery charging system with internal power manager. However, none of them disclosed a wireless power charger. Further, a traveler has to bring the power charger with himself. The power supply standard sometime does not match to the one of the device. Therefore, it is inconvenient to the user.

### SUMMARY

An object of the present invention is to provide a wireless charger having solar cells, which is capable of providing sufficient electric power to the portable device.

In order to accomplish the above object, the present invention provides a wireless charger for portable device comprising a main body or housing for receiving a control unit; a charging connector coupled to the control unit to engage the portable device; a solar cell array coupled to the control unit to charge the portable device. The solar cell is attached on the outer surface of the portable device, on a belt of a bag for carrying the portable device or on a retractable structure of the portable device.

The wireless charger can be a stand alone device or be integrated into a portable device. The portable device comprising a main body; a display and a keypad formed on the main body; a MP3 or MP4 codec formed within the main body; a memory coupled to the MP3 or MP4 codec; an audio process coupled to the MP3 or MP4 codec; a D/A converter coupled to the audio process; a solar cell array attached to an outer surface of the main body so as to be exposed to an external environment for generating a voltage when light is received. The memory includes nonvolatile memory or hard disc.

Alternatively, the portable device comprising: a main body having a process; a display formed on the main body and coupled to the processor; an image capture element formed within the main body; a memory coupled to the processor, a lens mechanism formed on the main body and corresponding to the image capture element; a solar cell array coupled to the portable device so as to be exposed to an external environment for generating a voltage when light is received. The memory includes nonvolatile memory or hard disc.

Further more, the portable device comprising a main body; a display and a keypad formed on the main body; a flip cover for increasing surface area of solar cell area; a solar cell array attached to an inner surface of the flip cover and/or the area of the main body covered by the flip cover so as to be exposed to an external environment for generating a voltage when light is received.

The portable device comprises a main body having a control unit contain therein; a keypad formed on the main body; a controlling signal transmitter coupled to the control unit and in responsive to the key of the keypad to transmit a remote signal; a solar cell array attached to an outer surface of the main body so as to be exposed to an external environment for generating a voltage when light is received.

Further, the device comprises a main body and a processor contain therein; an internet connector coupled to the processor for connecting to remote terminal through internet; a wireless transceiver coupled to said processor to receive and transmit 802.11x spec. signal for wireless communication. The wireless charger coupled to the device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the appearance of a charging module with a solar cell in accordance with an embodiment of the present invention;

FIG. 2 is a block diagram showing the appearance of a charging module with a terminal device in accordance with another embodiment of the present invention;

FIG. 3 is a block diagram showing the appearance of a charging module with a terminal device in accordance with another embodiment of the present invention;

FIG. 4 is a block diagram showing the appearance of a charging module with a terminal device in accordance with another embodiment of the present invention;

FIG. 5 is a block diagram showing the appearance of a charging module with a terminal device in accordance with another embodiment of the present invention;

FIG. 6 is a block diagram showing the appearance of a charging module with a terminal device in accordance with another embodiment of the present invention;

FIG. 7 is a block diagram showing the appearance of a charging module with a terminal device in accordance with another embodiment of the present invention;

FIG. 8 is a block diagram showing the appearance of a charging module with a terminal device in accordance with another embodiment of the present invention.

FIG. 9 is a block diagram showing the appearance of a charging module with a terminal device in accordance with another embodiment of the present invention;

FIG. 10 is a block diagram showing the appearance of a charging module with a terminal device in accordance with another embodiment of the present invention.

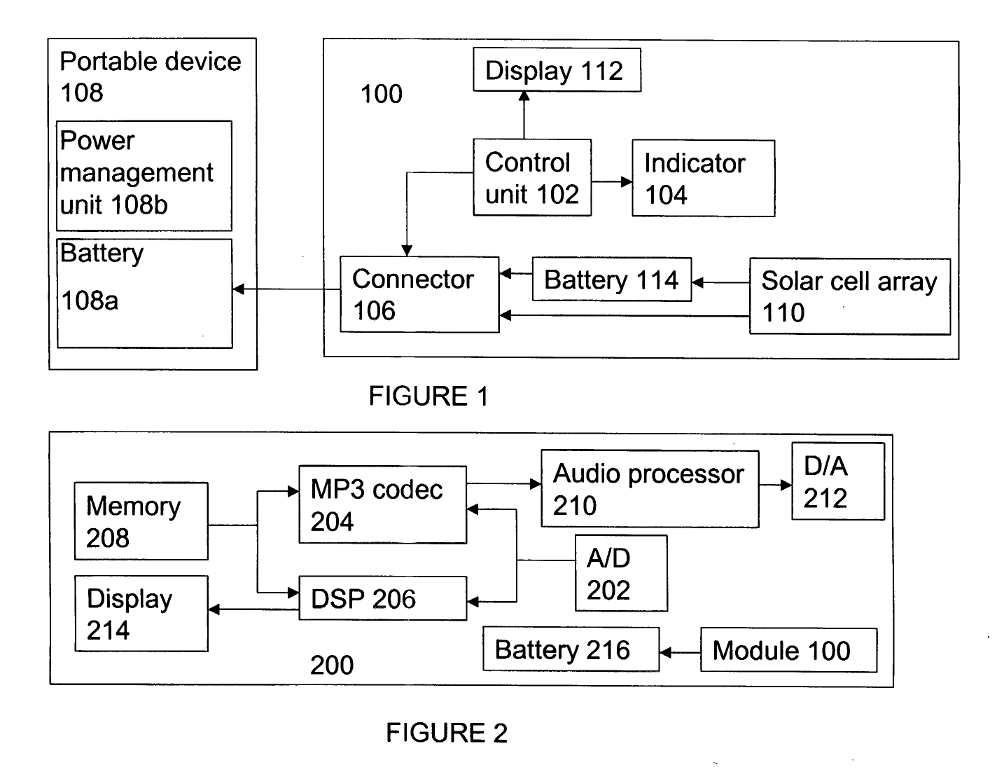

### BEST MODE FOR CARRYING OUT THE INVENTION

The present invention provides a wireless charger (or charging module) for portable device such as mobile phone, PDA, MP3, MP4 player, portable DVD, VCD, AP (access point), remoter, digital camera or the like. The charger includes a housing (or main body) 100 to receive the control unit 102 therein, a general purpose indicator 104 is coupled to the control unit 102 indicate the status of the charging. A charging connector (or engaging element) 106 is coupled to the control unit 102 to allow the electricity to be charged into the device 108 under charging. Typically, the connector 106 is coulpled to the battery 108a of the device or the power management unit 108b of the device. A solar cell array (or solar cells) 110 maybe coupled to the control unit 102 to receive the illumination. The charger may charge the battery 108a of the device 108, directly. Alternatively, the present invention may optionally include a battery 114 to store the electricity generated from the solar cell array. The charging module may charge a portable device through the battery 114. The wireless charger may includes a display 112 coupled to the control unit to display status, date, time, temperature, moisture, information or the like. The display 112 and the indicator 104 are both optional element for the charging module. If the charging module 100 is built-in in any portable device, the connector maybe omitted or replaced by other coupling type or circuitry.

The wireless charging module 100 may engage to the external device 108 through the charging connector 106. The sensor of the device 108 can sense whether the charging connector 106 is coupled to the device or not. Therefore, the wireless charger 100 may provide the electricity power to the device 108 wirelessly. The problems mentioned in the background are solved. The wireless charger may be provided to any portable device such as portable phone, walkman, portable TV, portable DVD player, portable CD player, PDA, display, digital camera, GPS device, MP3, MP4 player, AP, remoter, notebook, palm computer or the like.

In one case, the solar cell array can be attached on the outer surface of the charger. Alternatively, it could be formed on the surface of the flip cover of the charger, or extensible slice from the charger. Alternatively, a retraceable mechanism can be used to attach the solar cell. The structure may enlarge the surface area. Alternatively, the solar cell array may be attached on the belt of the bag for carrying the camera, notebook or the like. Therefore, the charging module can be engaged to the device via the connector 106 or separated from the device. The connector 106 includes charging circuits for charging the device as know in the art.

The wireless charger or charging module 100 may be a stand-alone device or be integrated into those device mentioned above. The solar cell may be fabricated of one of various materials such as silicon (Si), gallium arsenide (GaAs), cadmium sulphide (CdS), indium phosphide (InP) and combinations thereof. However, the solar cell is preferably formed of silicon from cost reduction point of view. A booster circuit is needed for increasing the photo voltage to the electric source voltage of the portable device. The booster circuit could be formed in the charger side or the portable device side.

If the charger 100 having solar cells is employed for MP3 player, MP4 player, the solar cell may be formed at the outer surface of the main body of the player if the charging module is integrated into the device. FIG. 2 illustrates a portable media player 200 in one embodiment of the invention. It should be noted, the charger 100 maybe a build-in module of the portable device or another stand-alone device. Player 200 includes an analog/digital (A/D) converter 202 for converting analog audio signals into digital audio signals. The analog audio signals can come from an audio source coupled to player 200. A digital signal processor (DSP) 204 or an audio and/or video driving module 206, for instance MP3, MP4 codec, are coupled to A/D converter 202 to receive the digital audio signals. In one embodiment, MP3 or MP4 codec 206 executes a firmware that includes a MPEG audio layer (e.g., MP3, MP2, or both) codec or video codec (e.g., MP4), and DSP 204 executes a firmware that includes a different type of audio codec (e.g., WMA, ACC, or both). In one embodiment, the firmware for DSP 204 also includes a video codec for encoding and decoding videos (e.g., MPEG-4 V1/V2/V3, DivX 3.11/4.0/5.0, Xvid, AVI/ASF, or any combination thereof. MP3 (or MP4) codec 206 and DSP 204 are coupled to a nonvolatile memory 208 that stores the compressed audio data. The user can select an audio file from nonvolatile memory 208. DSPs 204 and 206 are coupled to an audio processor 210, which processes the digital audio signals according to default settings or user instructions. Audio processor 210 is coupled to a digital/analog (D/A) converter 212, which converts the digital audio signals into analog audio signals for the user. A display 214 is coupled to the DSP 206.

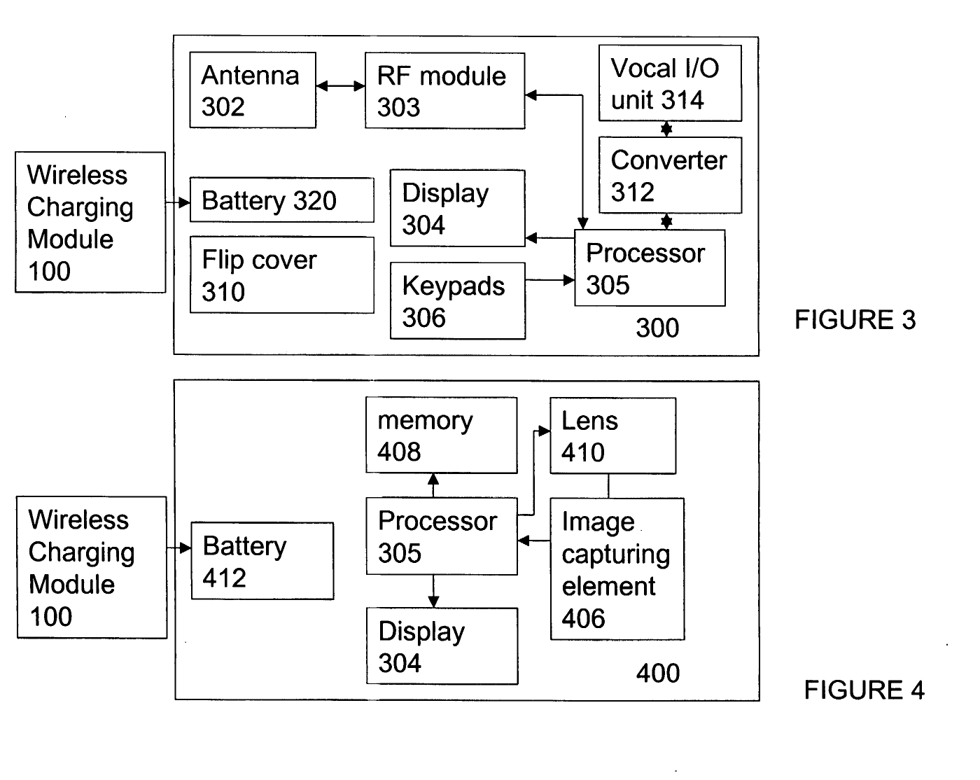

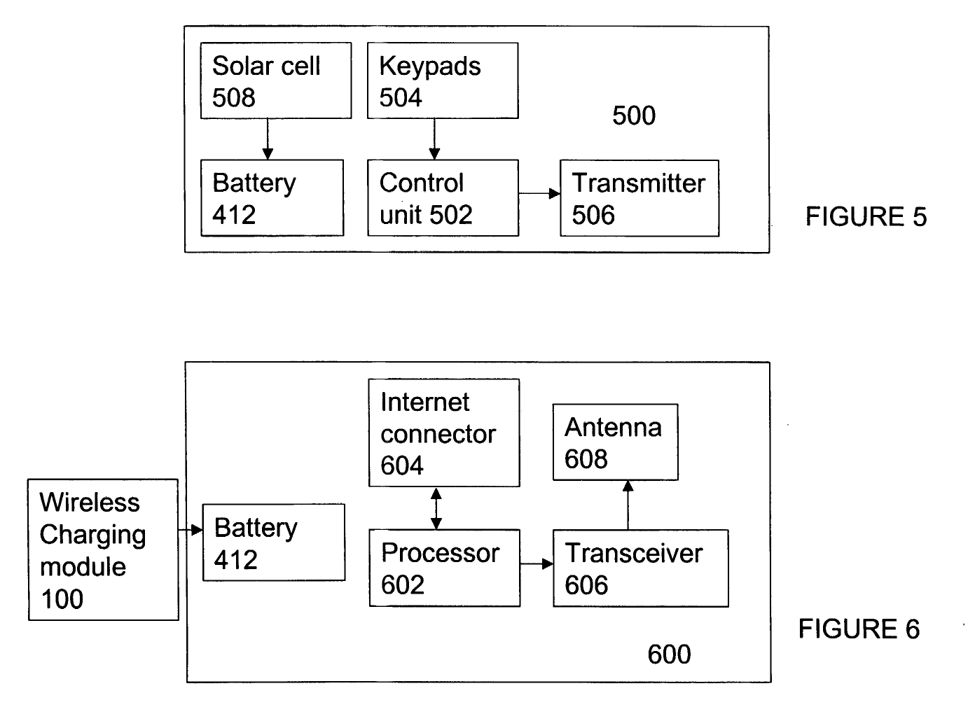

Please refer to FIG. 3, a portable terminal in accordance with the present invention generally comprises a main body 300 for receiving the components of the device, a reception portion 302 to receive the transmitted data, the reception portion 302 can be an antenna. A radio frequency (RF) module 303 is coupled to the antenna 302 and a control unit 305 is coupled to the radio frequency module 303. A display 304 and a keypad 306 are formed on the upper surface of the main body 300 and coupled to the control unit 305. It should be noted that the control unit 305 may includes DSP, MCU. The DSP and MCU may be separated processors or an integrated processor such as SOC (system on chip). In accordance with a feature of the present invention, a solar cell 308 is attached to the flip cover 310. The keypad 306 is disposed on the outer surface of the flip cover 310 for inputting the instruction. Alternatively, the keypad 306 and the display 304 are both formed on the outer surface of the flip cover 310.

When the mobile terminal of the present invention is deposited on a desk or the top of any article, light reaches the solar cell and the solar cell generates electricity. According to the present invention, since the solar cells 308 needs larger area to receive light, the flip cover 310 can be flipped and the solar cells 308 are attached on the inner surface of the flip cover and the covered surface of the upper surface of the main body 300 covered by the flip cover 310. Under such arrangement, the solar cell area can be extended twice of the cover area, thereby increasing the receiving area of the solar cell. The solar cells can be disposed all over the entire inner surface of the flip cover and the main body, the solar cell 308 can generate sufficient electricity necessary for charging the battery of the mobile terminal. The electricity generated by the solar cell 308 may be supplied from the solar cell 308 to the battery through contacts or a flexible cable. The voltage generated by the solar cell is greater than a predetermined voltage, the solar cell is rendered not to supply electricity to the battery by a semiconductor relay. A converter 312 is coupled to the processor 305 for converting the data between digital and analog. An audio I/O unit 314 is coupled to the converter 312 for audio signal input and output.

The hinge for the flip cover 310 can be formed at the side edge of the portable device or lower end of the terminal. A lithium-ion battery is disposed and sealed in the main body, the lithium-ion battery will be continuously charged with electricity by the solar cell during standby for the receipt. Alternatively, the charging module 100 having solar cell array coupled to the battery 320 of the portable device 300 so as to be exposed to an external environment for generating a voltage when light is received.

Meanwhile, according to the present invention, since the battery is charged by the solar cell from time to time, a lithium-ion battery without a memory effect or the other conventional batteries having such characteristics may be preferably utilized for the mobile terminal of the present invention. The portable device includes but not limited to cordless phone, a Portable Digital Assistant (PDA), a palmtop computer, MP3 player, MP4 player, camera or the like.

Further, referring to FIG. 4, the device includes a main body 400 having a process 402; a display 404 formed on the main body and coupled to the processor 402; an image capture element 406 formed within the main body and coupled to the processor 402; a memory 408 coupled to the processor; a lens mechanism 410 formed on the main body, coupled to the processor 402 and corresponding to the image capture element 406; the charging module 100 having solar cell array coupled to the battery 412 of the portable device 400 so as to be exposed to an external environment for generating a voltage when light is received.

The charging module can be employed for a remoter comprising: a main body 500 having a control unit (processor) 502 contained therein; a keypad 504 formed on the main body 500; a controlling signal transmitter 506 coupled to the control unit 502 and in responsive to the key of the keypad 504 to transmit a remote signal; the solar cell array 508 attached to an outer surface of the main body and coupled to the battery 510 so as to be exposed to an external environment for generating a voltage when light is received.

Furthermore, the device having wireless charging module 100 comprises a main body 600 (FIG. 6) and a processor 602 contained therein; an internet connector 604 is coupled to the processor 602 for connecting to remote terminal through internet; a wireless transceiver 606 is coupled to the processor 602 to receive and transmit 802.11x spec. signal for wireless communication. The wireless charging module 100 is coupled to the battery 612 of the device. The solar cell array maybe formed on the device. It may be applied to AP (access point), router, gateway and so on. As known in the art, these devices also include antenna 608 coupled to the processor 602. These device such as AP is not the feature of the present invention, thus, the detailed description is omitted. The wireless charger 100 can be integrated into the AP and coupled to the corresponding element, for instance battery or power management unit, of the access point.

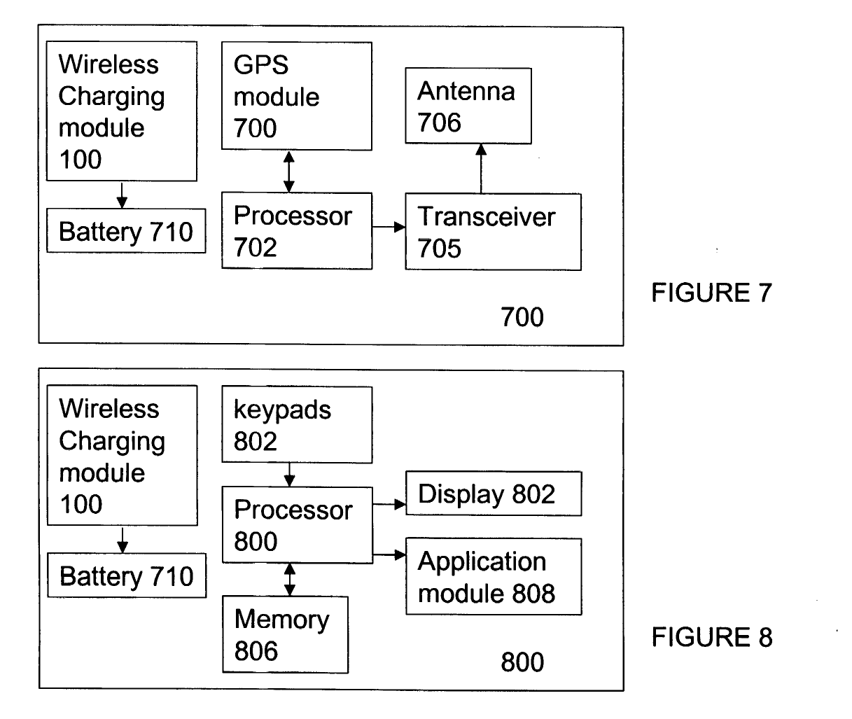

By the similar arrangement, the charging module 100 can be integrated into or coupled to the device having GPS module 700 coupled to a processor 702 as shown in FIG. 7. As known, the GPS device may include the transceiver 705 and the antenna 704 coupled to the processor for transmitting. However, the GPS module is not the feature of the present invention, thus, the detailed description is omitted. As shown in FIG. 8, wherein the wireless charging module can be integrated into the portable device or coupled to the portable device comprising: processor 800 formed within the portable device; a keypad 802 formed on the portable device; a display 804 coupled the processor; a memory 806 coupled to said processor 800. The device further includes an application module 808 is coupled to the processor, and the application module includes a TV module, a DVD player, MP4 player or VCD player. Similarly, the charging module 100 can be coupled to the battery 710 in FIG. 7 and 8.

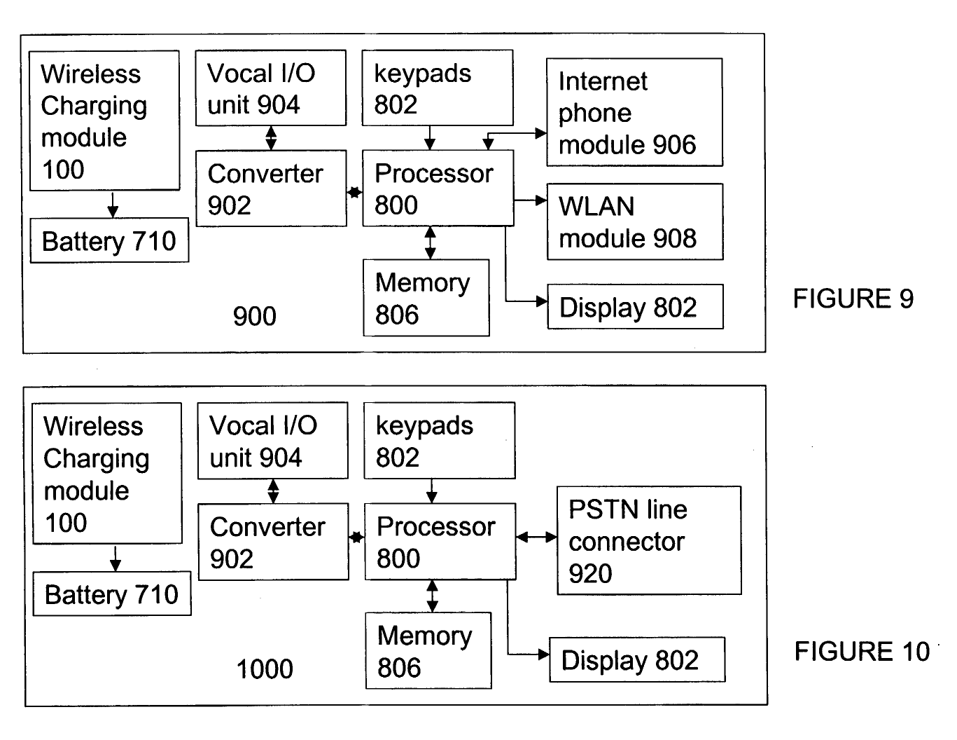

FIG. 9 illustrates a portable internet phone 900 with a wireless charging module 700, wherein the wireless charging module is integrated into the portable device or coupled to the portable device. The portable device comprises a processor 800 formed within the portable device; a keypad 802 is formed on the portable device. A display 802 is coupled the processor 800 and a memory 806 is coupled to the processor. An internet phone module 906 and a WLAN module 908 are both coupled to the processor 800. The WLAN module 908 is compatible with the 802.11x, Bluetooth, WiFi, WiMax specification and allows the internet phone linking to the internet. The Internet phone module 906 allows the internet phone process the voice or image communication through the internet and may be compatible with the VoIP specification. In one embodiment, the internet phone module 906 includes Skype™ module or the like. A converter 902 is coupled to the processor for converting the data between digital and analog. An audio I/O unit 904 is coupled to the converter 902 for audio information input and output.

FIG. 10 illustrates a PSTN phone 1000 with a wireless charging module 700. The wireless charging module 700 is integrated into or coupled to the PSTN phone comprising a processor 800 is formed within the portable device and a keypad 802 is formed on the phone. A PSTN line connector 920 is coupled to the processor 800. Other elements are similar to the device in FIG. 9.

As described above, the present invention provides a mobile terminal solar cell charger, which is capable of obtaining electricity simply by coupling the mobile terminal on a desk or table, thereby supplying electricity for the device and the charging of its battery. The consumption of the battery can be minimized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wireless charging module for a portable device comprising:
a housing for receiving a control unit;
a charging connector coupled to said control unit to engage said portable device;
a solar cell array coupled to said control unit to charge said portable device, wherein
said solar cell array is provided so as to be exposed to an external environment for generating a voltage when light is received.

2. The wireless charging module of claim 1, wherein said wireless charging module is integrated into said portable device or coupled to said portable device, said portable device comprising:
a display and a keypad formed on said portable device;
an audio or video driving module formed within said portable device;
a memory coupled to said audio or video driving module;
an audio process coupled to said audio or video driving module;
a D/A converter coupled to said audio process.

3. The wireless charging module claim 2, wherein said memory includes nonvolatile memory or hard disc.

4. The wireless charging module of claim 1, wherein said wireless charging module is integrated into said portable device or coupled to said portable device, said portable device comprising:
a process;
a display formed on said portable device and coupled to said processor;
an image capture element formed within said portable device and coupled to said processor;
a memory coupled to said processor;
a lens mechanism formed on said portable device and corresponding to said image capture element.

5. The wireless charging module claim 4, wherein said memory includes nonvolatile memory or hard disc.

6. The wireless charging module of claim 5, wherein said solar cell is attached on the outer surface of said portable device, a belt of a bag for carrying said portable device or a retractable structure of said portable device.

7. The wireless charging module of claim 1, wherein said wireless charging module is integrated into said portable device or coupled to said portable device, said portable device comprising:
a display and a keypad formed on said portable device;
a DSP processor formed within said portable device;
a radio frequency module coupled to said DSP processor;
an antenna coupled to said radio frequency module.

8. The wireless charging module of claim 7, wherein said solar cell array is attached on the outer surface of said portable device, a belt of a bag for carrying said portable device or a retractable structure of said portable device.

9. The wireless charging module of claim 8, further comprising a flip cover; said solar cell array being attached to a surface of said flip cover so as to be exposed to an external environment for generating a voltage when light is received.

10. The wireless charging module of claim 1, wherein said wireless charging module is integrated into said portable device or coupled to said portable device, said portable device comprising:
a processor;
a keypad formed on said portable device;
a controlling signal transmitter coupled to said processor and in responsive to the key of said keypad to transmit a remote signal.

11. The wireless charging module of claim 1, wherein said wireless charging module is integrated into said portable device or coupled to said portable device, said portable device comprising:
a keypad formed on said portable device;
a GPS module formed within said portable device; and
a signal transmitter coupled to said GPS module to transmit or receive a signal.

12. The wireless charging module of claim 1, wherein said wireless charging module is integrated into said portable device or coupled to said portable device, said portable device comprising:
a processor formed within said portable device;
a keypad formed on said portable device;
a display coupled said processor;
a memory coupled to said processor.

13. The wireless charging module of claim 12, wherein said portable device includes a PDA or notebook.

14. The wireless charging module of claim 12, wherein said portable device includes a TV module.

15. The wireless charging module of claim 12, wherein said portable device includes a DVD player, MP3, player, MP4 player or VCD player.

16. The wireless charging module of claim 1, wherein said wireless charging module is integrated into said portable device or coupled to said portable device, said portable device comprising:
a processor formed within said portable device;
a keypad formed on said portable device;
a display coupled said processor;
a memory coupled to said processor;
an internet phone module coupled to said processor;
a WLAN module coupled to said processor.

17. The wireless charging module of claim 1, wherein said wireless charging module is integrated into said portable device or coupled to said portable device, said portable device comprising:
a processor formed within said portable device;
a keypad formed on said portable device;
a display coupled said processor;
a memory coupled to said processor;
a PSTN line connector coupled to said processor.
